(19) United States
(12) Patent Application Publication
(10) Pub. No.: US 2026/0051684 A1
(43) Pub. Date: Feb. 19, 2026

(54) ELECTRICAL CONNECTOR WITH ABUTMENT PIECE FOR GUIDING INSERTION OF MATING TONGUE PLATE

(71) Applicant: DONGGUAN LUXSHARE TECHNOLOGIES CO., LTD., Dongguan City (CN)

(72) Inventor: Kunlin Yao, Dongguan City (CN)

(73) Assignee: DONGGUAN LUXSHARE TECHNOLOGIES CO., LTD., Dongguan City (CN)

(21) Appl. No.: 18/915,905

(22) Filed: Oct. 15, 2024

(30) Foreign Application Priority Data
Aug. 15, 2024 (CN) 202421984802.6

(51) Int. Cl. H01R 13/24; H01R 12/72; H01R 13/05; H01R 13/447; H01R 13/502

(52) U.S. Cl. CPC H01R 13/2407; H01R 12/72; H01R 13/05; H01R 13/447; H01R 13/502

(57) ABSTRACT

An electrical connector includes a body portion, a number of conductive terminals, a first abutment piece and a second abutment piece. The body portion includes a mating slot configured to at least partially receive a mating tongue plate. The mating tongue plate includes a first side surface and a second side surface. Each conductive terminal includes a contact portion protruding into the mating slot. The first abutment piece includes a first abutting elastic arm. The second abutment piece includes a second abutting elastic arm. The first abutting elastic arm and the second abutting elastic arm are configured to abut against the first side surface and the second side surface of the mating tongue plate, respectively, to guide the mating tongue plate.

### CROSS-REFERENCE TO RELATED APPLICATION

This patent application claims priority of a Chinese Patent Application No. 202421984802.6, filed on Aug. 15, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

Electrical connectors in the related art generally include an insulating body and a plurality of conductive terminals fixed to the insulating body. The insulating body includes a mating surface and a mating slot extending through the mating surface. Each conductive terminal includes a contact portion extending into the mating slot and configured to be electrically connected to a mating connector. The mating connector generally includes a mating tongue plate provided with a plurality of conductive pads. During mating, the mating tongue plate is inserted into the mating slot, so that the conductive pads contact the conductive terminals to achieve electrical connection.

In order to increase the data transmission rate, the plurality of conductive terminals in the related art usually include a plurality of pairs of differential signal terminals and a plurality of ground terminals located on two sides of each pair of differential signal terminals. In some cases, the mating tongue is made of a printed circuit board.

It is understandable to those skilled in the art that a thickness of the mating tongue plate made of the printed circuit board cannot be manufactured to be very thick due to its manufacturing process. In other words, when the mating tongue plate is inserted into the mating slot, the mating tongue plate is easily affected by external forces and shakes in a top-bottom direction, which is not conducive to maintaining mating reliability.

In addition, and more importantly, as the density of conductive terminals continues to increase, a width of each conductive terminal itself is being reduced. Correspondingly, a width of the conductive pad on the mating tongue plate is also reduced.

When the mating tongue plate is inserted into the mating slot, in order to avoid difficulty in inserting the mating tongue plate due to excessive mating accuracy requirements, the width of the mating slot in the related art is usually designed to be larger than the width of the mating tongue plate. However, a subsequent problem is that after the mating tongue plate is inserted into the mating slot, the mating tongue plate is easily offset in a width direction of the mating slot, causing the conductive pads and the conductive terminals to be misaligned, thereby affecting the mating reliability.

Therefore, it is desirable to improve the electrical connector in the related art.

### SUMMARY

An object of the present disclosure is to provide an electrical connector with improved mating reliability.

In order to achieve the above object, the present disclosure adopts the following technical solution: an electrical connector, including: a body portion, the body portion including a mating surface and a mating slot extending through the mating surface along a first direction; the mating slot being configured to at least partially receive a mating tongue plate along a second direction opposite to the first direction; the mating tongue plate including a first side surface and a second side surface opposite to the first side surface; a plurality of conductive terminals, the plurality of conductive terminals being provided on the body portion; each conductive terminal including an elastic contact arm which includes a contact portion protruding into the mating slot; a first abutment piece, the first abutment piece being provided on the body portion, the first abutment piece including a first abutting elastic arm protruding into the mating slot; and a second abutment piece, the second abutment piece being provided on the body portion, the second abutment piece including a second abutting elastic arm protruding into the mating slot; wherein the first abutting elastic arm and the second abutting elastic arm are disposed on two sides of the mating slot, respectively, along a third direction; the third direction is perpendicular to the first direction and the second direction; the first abutting elastic arm protrudes toward the second abutting elastic arm along the third direction; the second abutting elastic arm protrudes toward the first abutting elastic arm along the third direction; the first abutting elastic arm and the second abutting elastic arm are configured to abut against the first side surface and the second side surface of the mating tongue plate, respectively, so that the mating tongue plate is caused to adjust contact positions with the contact portions of the conductive terminals along the third direction during a process of inserting the mating tongue plate into the mating slot.

In order to achieve the above object, the present disclosure adopts the following technical solution: an electrical connector, including: a body portion, the body portion including a mating surface and a mating slot extending through the mating surface along a first direction; the mating slot being configured to at least partially receive a mating tongue plate along a second direction opposite to the first direction; the mating tongue plate including a first side surface, a second side surface opposite to the first side surface and a plurality of conductive pads; a plurality of conductive terminals, the plurality of conductive terminals being fixed to the body portion; each conductive terminal including an elastic contact arm which includes a contact portion protruding into the mating slot; a first abutment piece, the first abutment piece being fixed to the body portion, the first abutment piece including a first abutting elastic arm protruding into the mating slot; and a second abutment piece, the second abutment piece being fixed to the body portion, the second abutment piece including a second abutting elastic arm protruding into the mating slot; wherein the first abutting elastic arm and the second abutting elastic arm are disposed on two sides of the mating slot, respectively, along a third direction which is perpendicular to the first direction and the second direction; the first abutting elastic arm and the second abutting elastic arm are configured to abut against the first side surface and the second side surface of the mating tongue plate, respectively, to adjust a position of the mating tongue plate along the third direction when the mating tongue plate is inserted into the mating slot, ensuring that the contact portions of the conductive terminals are accurately in contact with corresponding conductive pads of the mating tongue plate.

In order to achieve the above object, the present disclosure adopts the following technical solution: an electrical connector, including: a body portion including a mating surface, a mating slot extending through the mating surface along a first direction, a first side wall located on one side of the mating slot, and a second side wall located on another side of the mating slot; the first side wall defining a first fixing groove; the second side wall defines a second fixing groove; the mating slot being configured to at least partially receive a mating tongue plate along a second direction opposite to the first direction; the mating tongue plate including a first side surface, a second side surface opposite to the first side surface and a plurality of conductive pads; a first terminal module including a first insulating block and a plurality of first conductive terminals fixed to the first insulating block; the first terminal module being assembled to the body portion; the plurality of first conductive terminals extending into the mating slot; a second terminal module including a second insulating block and a plurality of second conductive terminals fixed to the second insulating block; the second terminal module being assembled to the body portion; the plurality of second conductive terminals extending into the mating slot; a first abutment piece including a first main body portion fixed in the first fixing groove and a first abutting elastic arm integrally stamped from the first main body portion; and a second abutment piece including a second main body portion fixed in the second fixing groove and second abutting elastic arm integrally stamped from the second main body portion; wherein the first abutting elastic arm and the second abutting elastic arm are disposed on two sides of the mating slot, respectively, along a third direction which is perpendicular to the first direction and the second direction; wherein a width of the mating slot along the third direction is larger than a width of the mating tongue plate between the first side surface and the second side surface, so that the mating tongue plate can be easily inserted into the mating slot; and wherein the first abutting elastic arm and the second abutting elastic arm are configured to abut against the first side surface and the second side surface of the mating tongue plate, respectively, to adjust a position of the mating tongue plate along the third direction when the mating tongue plate is inserted into the mating slot, ensuring that the plurality of first conductive terminals and the plurality of second conductive terminals are accurately in contact with corresponding conductive pads of the mating tongue plate.

Compared with the prior art, the electrical connector of the present disclosure is provided with the first abutment piece and the second abutment piece. The first abutting elastic arm and the second abutting elastic arm are located on two sides of the mating slot, respectively, along the third direction. The first abutting elastic arm protrudes toward the second abutting elastic arm along the third direction. The second abutting elastic arm protrudes toward the first abutting elastic arm along the third direction. The first abutting elastic arm and the second abutting elastic arm are configured to abut against the first side and the second side of the mating tongue plate, respectively, so that when the mating tongue plate is inserted into the mating slot, contact positions of the mating tongue plate with the contact portions of the conductive terminals can be adjusted along the third direction. The present disclosure improves the mating reliability of the electrical connector when mating with the mating tongue plate.

### BRIEF DESCRIPTION OF DRAWINGS

FIG. 1 is a schematic perspective view of a connector assembly in accordance with an embodiment of the present disclosure, in which a mating tongue plate is inserted into an electrical connector;

FIG. 2 is a perspective view of FIG. 1 from another angle;

FIG. 3 is a partially exploded perspective view of FIG. 1, in which the mating tongue plate and the electrical connector are separated from each other;

FIG. 4 is a partially exploded perspective view of FIG. 3 from another angle;

FIG. 5 is a front view of the electrical connector shown in FIG. 3;

FIG. 6 is a partially exploded perspective view of the electrical connector in FIG. 3, in which a first abutment piece and a second abutment piece are separated;

FIG. 7 is a partially exploded perspective view of FIG. 6 from another angle;

FIG. 8 is a partially exploded perspective view after removing the first abutment piece and the second abutment piece in FIG. 6, in which a first cover plate and a second cover plate are separated;

FIG. 9 is a partially exploded perspective view of FIG. 8 from another angle;

FIG. 10 is a further partially exploded perspective view of FIG. 8;

FIG. 11 is a partially exploded perspective view of FIG. 10 from another angle;

FIG. 12 is a perspective view of a first terminal module and a second terminal module in FIG. 10;

FIG. 13 is a perspective view of FIG. 12 from another angle;

FIG. 14 is an exploded perspective view of FIG. 12;

FIG. 15 is an exploded perspective view of FIG. 14 from another angle;

FIG. 16 is a schematic cross-sectional view taken along line B-B in FIG. 3;

FIG. 17 is a schematic cross-sectional view taken along line C-C in FIG. 1; and

FIG. 18 is a schematic cross-sectional view taken along line D-D in FIG. 1, in which an adapter circuit board is shown in dotted lines.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

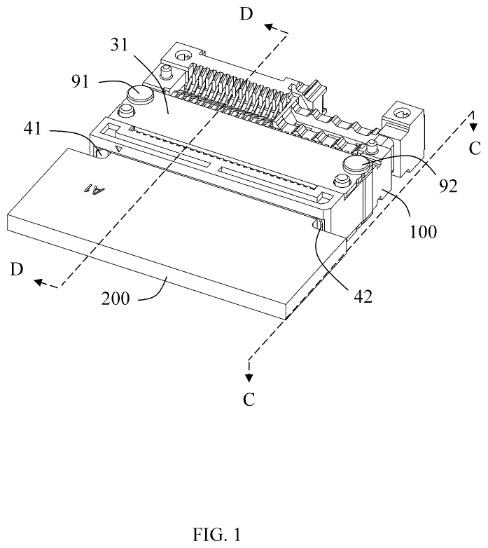

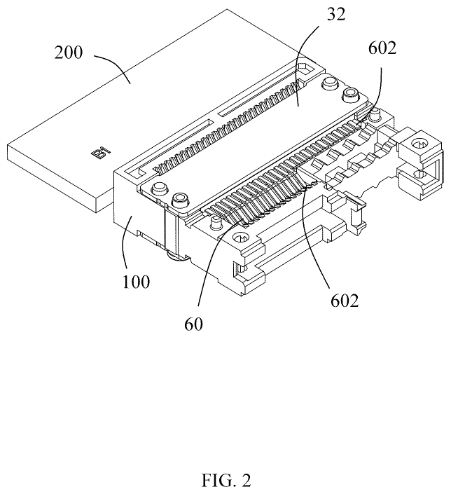

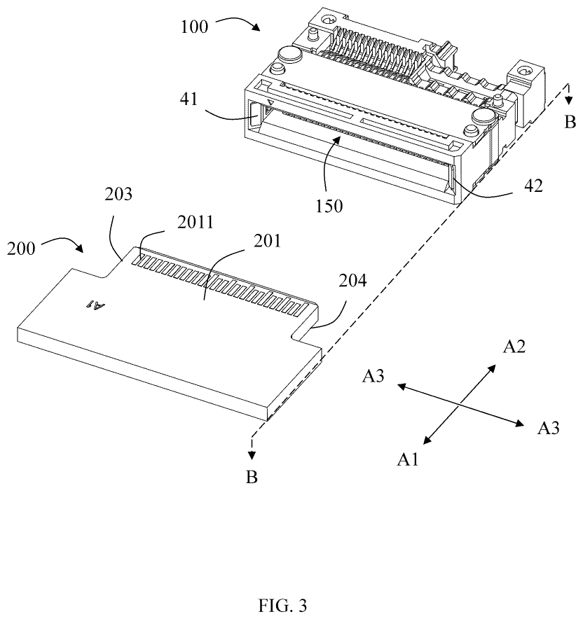

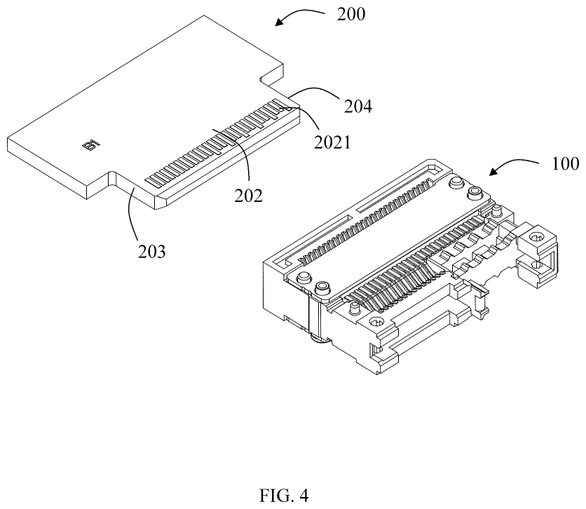

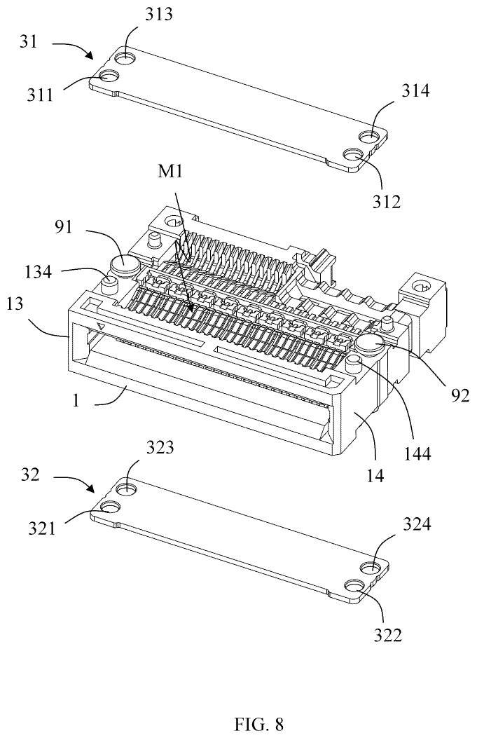

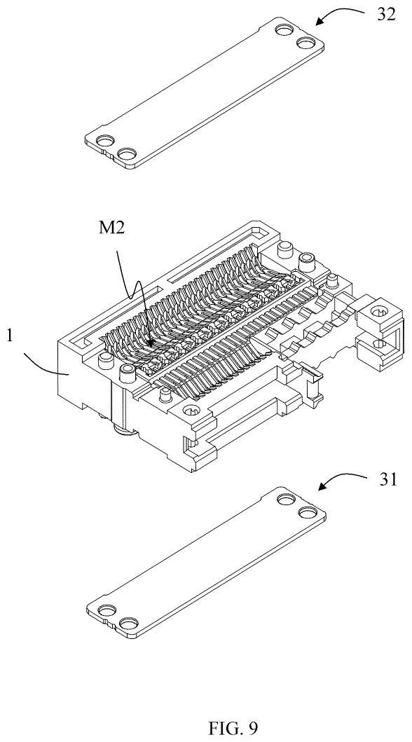

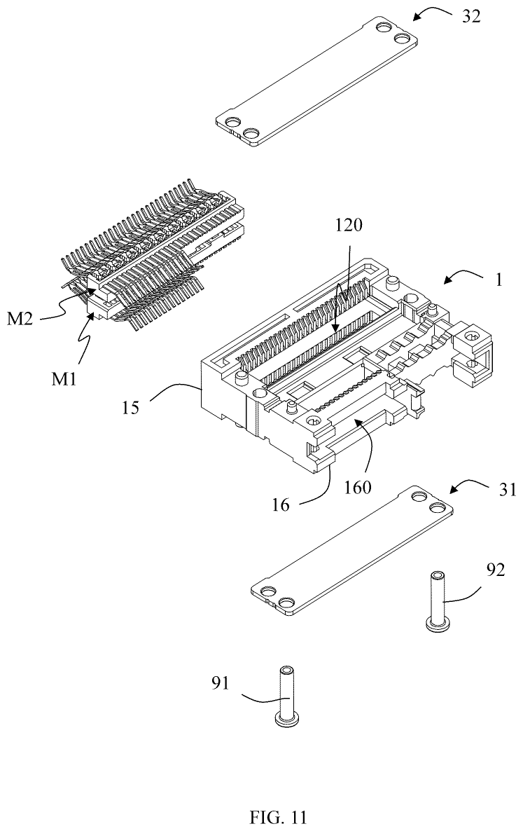

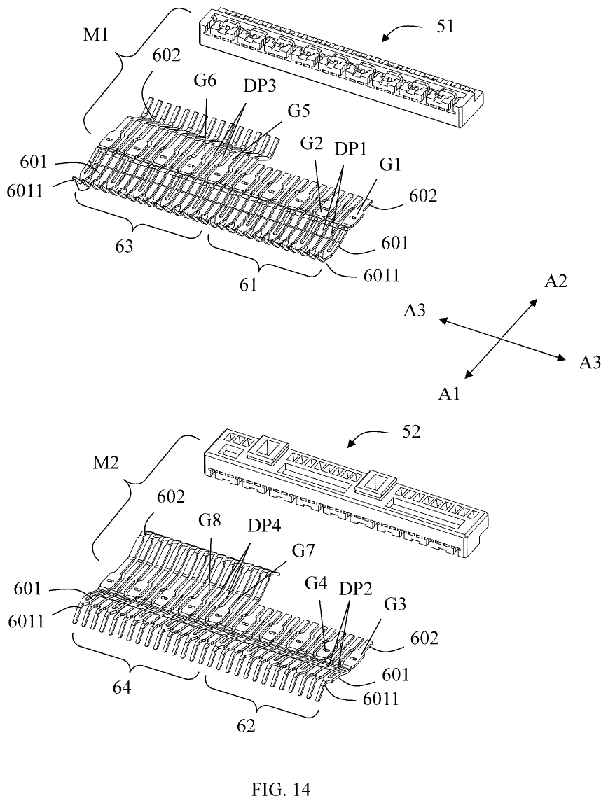

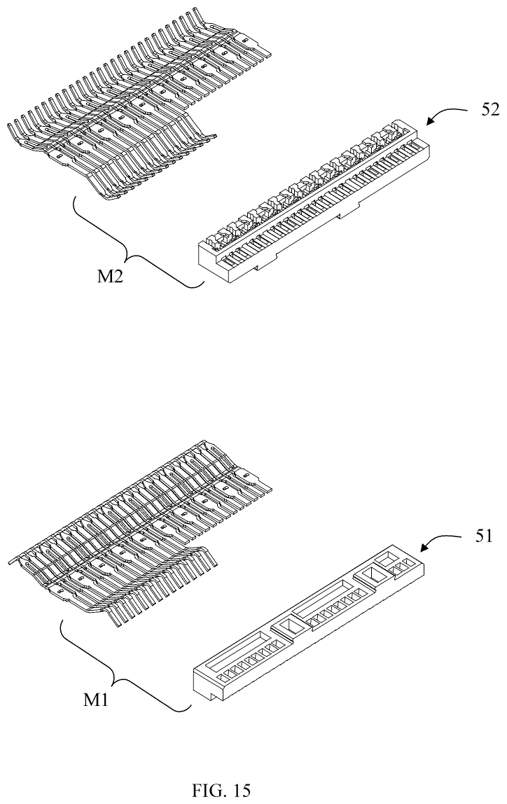

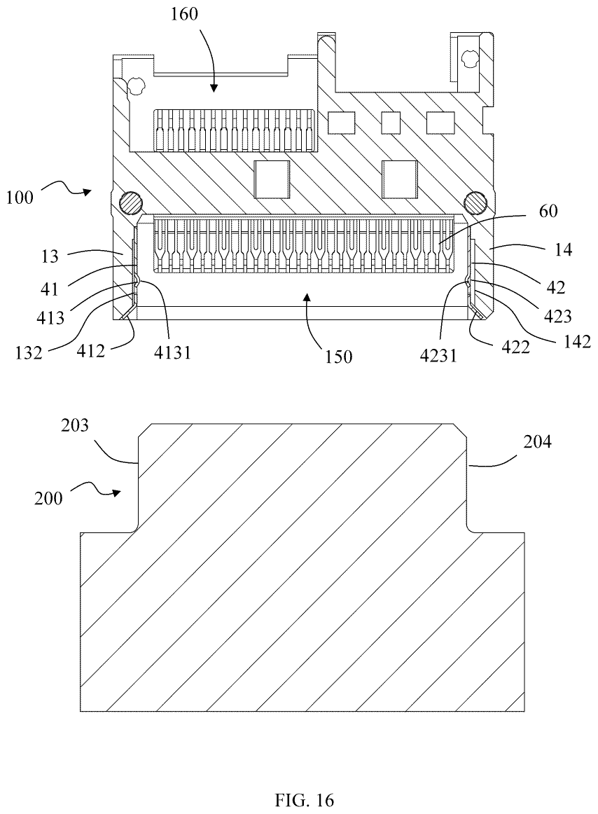

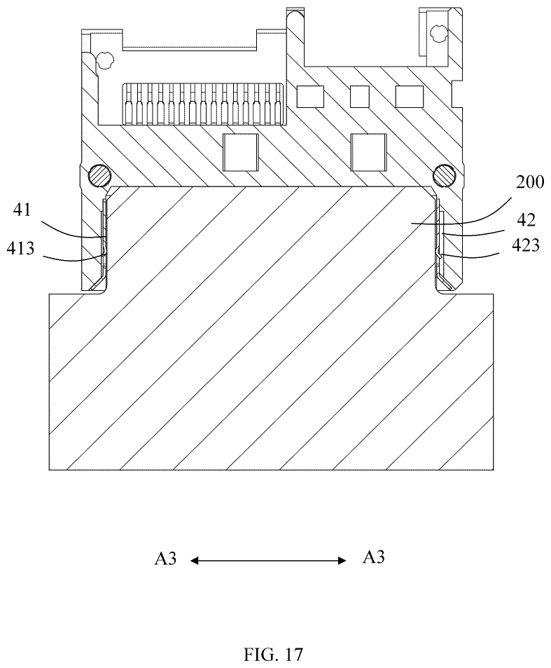

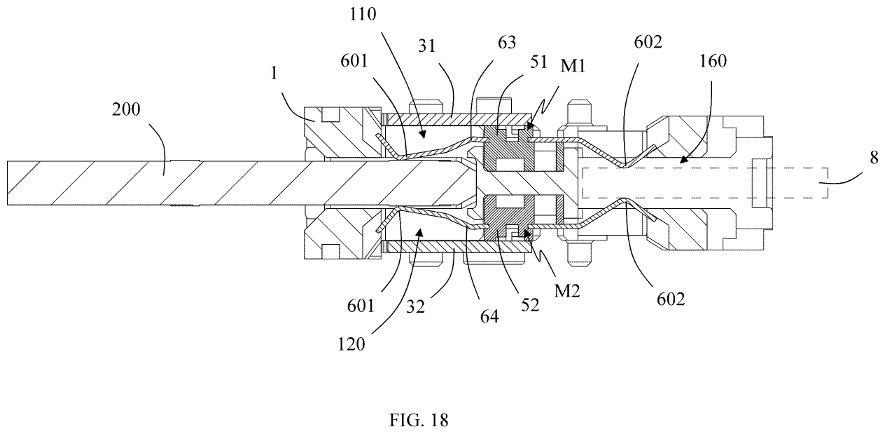

Referring to FIG. 1 to FIG. 18, the present disclosure discloses a connector assembly, which includes an electrical connector 100 and a mating tongue plate 200 for mating with the electrical connector 100.

Referring to FIG. 1 to FIG. 4, in one embodiment of the present disclosure, the mating tongue plate 200 is made of a printed circuit board (PCB). The mating tongue plate 200 includes an upper surface 201, a lower surface 202 opposite to the upper surface 201, a first side surface 203 (for example, a left side surface), and a second side surface 204 (for example, a right side surface) opposite to the first side surface 203. The mating tongue plate 200 includes a plurality of conductive pads. The plurality of conductive pads include a plurality of first conductive pads 2011 which are located on the upper surface 201 and are arranged at intervals, and a plurality of second conductive pads 2021 which are located on the lower surface 202 and are arranged at intervals. In the illustrated embodiment of the present disclosure, each of the first side surface 203 and the second side surface 204 is located in a vertical plane and extends in a front-rear direction.

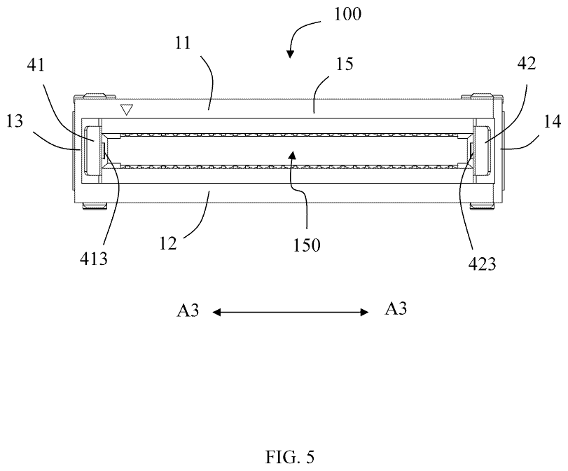

Referring to FIG. 5 to FIG. 11, the electrical connector 100 includes a body portion 1, a first terminal module M1 installed on the body portion 1, a second terminal module M2 installed on the body portion 1, a first cover plate 31 fixed to the body portion 1, a second cover plate 32 fixed to the body portion 1, a first abutment piece 41 mounted to the body portion 1, and a second abutment piece 42 mounted to the body portion 1.

In an embodiment of the present disclosure, the body portion 1 is an insulating body portion, that is, the body portion 1 is made of an insulating material. The body portion 1 includes a top wall 11, a bottom wall 12 opposite to the top wall 11, a first side wall 13 connecting one side of the top wall 11 and one side of the bottom wall 12, and a second side wall 14 connecting another side of the top wall 11 and another side of the bottom wall 12. The body portion 1 further includes a mating surface 15, a rear end surface 16 opposite to the mating surface 15, a mating slot 150 extending through the mating surface 15 along a first direction A1 (for example, a rear-to-front direction), and a mounting slot 160 extending through the rear end surface 16 along a second direction A2 (for example, a front-to-rear direction). The first direction A1 is opposite to the second direction A2. The mating slot 150 is jointly enclosed by the top wall 11, the bottom wall 12, the first side wall 13 and the second side wall 14.

In the illustrated embodiment of the present disclosure, the top wall 11 defines a first installation opening 110 extending upwardly through the top wall 11. The first terminal module M1 is installed in the first installation opening 110 along a top-bottom direction or a front-rear direction.

Similarly, the bottom wall 12 defines a second installation opening 120 extending downwardly through the bottom wall 12. The second terminal module M2 is installed in the second installation opening 120 along the top-bottom direction or the front-rear direction.

The first side wall 13 defines a first fixing groove 131 extending along the first direction A1 and a first relief groove 132 located outside the first fixing groove 131. The first side wall 13 is further provided with a first inclined surface 133 disposed adjacent to the mating surface 15. The first side wall 13 further includes a first positioning post 134 protruding upwardly, a second positioning post 135 protruding downwardly, and a first through hole 136 extending through the first side wall 13 along the top-bottom direction.

Similarly, the second side wall 14 defines a second fixing groove 141 extending along the first direction A1 and a second relief groove 142 located outside the second fixing groove 141. The second side wall 14 is further provided with a second inclined surface 143 disposed adjacent to the mating surface 15. The second side wall 14 further includes a third positioning post 144 protruding upwardly, a fourth positioning post 145 protruding downwardly, and a second through hole 146 extending through the second side wall 14 along the top-bottom direction. In the illustrated embodiment of the present disclosure, the first inclined surface 133 and the second inclined surface 143 form a bell mouth configuration.

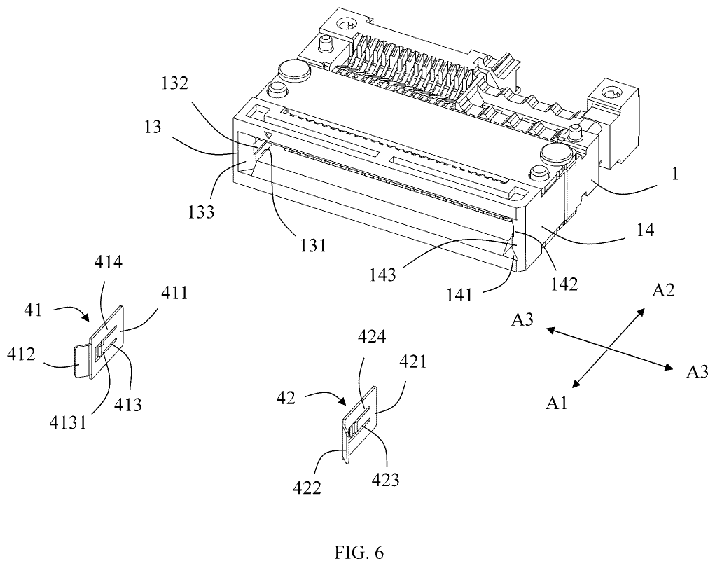

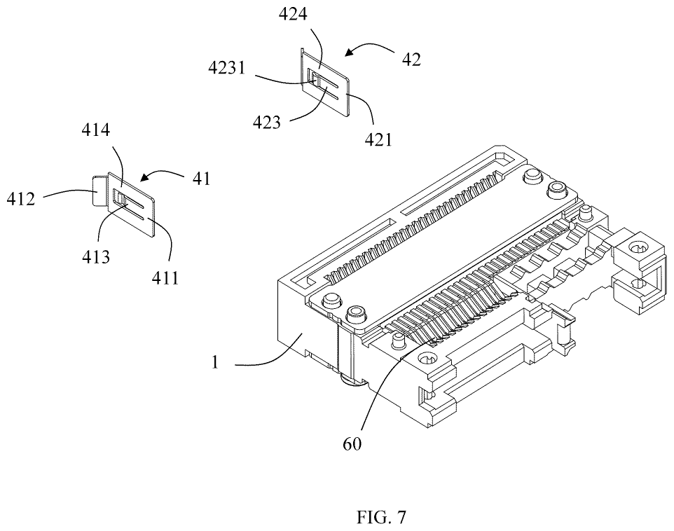

Referring to FIG. 6 and FIG. 7, the first abutment piece 41 is fixed to the body portion 1. In the illustrated embodiment of the present disclosure, the first abutment piece 41 includes a first main body portion 411 fixed in the first fixing groove 131 and a first deflection portion 412 extending from the first main body portion 411. The first main body portion 411 is inserted into and fixed in the first fixing groove 131 along the second direction A2. The first main body portion 411 includes a first abutting elastic arm 413 protruding into the mating slot 150. In the illustrated embodiment of the present disclosure, the first abutting elastic arm 413 is integrally stamped from the first main body portion 411. The first main body portion 411 includes a first frame portion 414 surrounding the first abutting elastic arm 413. By providing the first frame portion 414, it is beneficial to improving the structural strength of the first abutment piece 41. The first abutting elastic arm 413 extends along the first direction A1. The first abutting elastic arm 413 is provided with an arc-shaped first abutting surface 4131. The first abutting surface 4131 is configured to abut against the first side surface 203 of the mating tongue plate 200. The first abutting elastic arm 413 corresponds to the first relief groove 132, that is, the first abutting elastic arm 413 can be received in the first relief groove 132 when deforming laterally outward.

Similarly, the second abutment piece 42 is fixed to the body portion 1. In the illustrated embodiment of the present disclosure, the second abutment piece 42 includes a second main body portion 421 fixed in the second fixing groove 141 and a second deflection portion 422 extending from the second main body portion 421. The second main body portion 421 is inserted into and fixed in the second fixing groove 141 along the second direction A2. The second main body portion 421 includes a second abutting elastic arm 423 protruding into the mating slot 150. In the illustrated embodiment of the present disclosure, the second abutting elastic arm 423 is integrally stamped from the second main body portion 421. The second main body portion 421 includes a second frame portion 424 surrounding the second abutting elastic arm 423. By providing the second frame portion 424, it is beneficial to improving the structural strength of the second abutment piece 42. The second abutting elastic arm 423 extends along the first direction A1. The second abutting elastic arm 423 is provided with an arc-shaped second abutting surface 4231. The second abutting surface 4231 is configured to abut against the second side surface 204 of the mating tongue plate 200. The second abutting elastic arm 423 corresponds to the second relief groove 142, that is, the second abutting elastic arm 423 can be received in the second relief groove 142 when deforming laterally outward.

The first deflection portion 412 is in contact with the first inclined surface 133. The second deflection portion 422 is in contact with the second inclined surface 143. The first deflection portion 412 and the second deflection portion 422 are configured to guide the mating tongue plate 200 to be inserted into the mating slot 150 along the second direction A2.

In the illustrated embodiment of the present disclosure, both the first abutment piece 41 and the second abutment piece 42 are metal pieces. Such an arrangement can, on the one hand, help increasing the strength of two sides of the mating slot 150; on the other hand, be beneficial to conduct away the static electricity on the mating tongue plate 200 through the first deflection portion 412 and the second deflection portion 422 when the mating tongue plate 200 is just inserted into the mating slot 150.

It is understandable to those skilled in the art that in the illustrated embodiment of the present disclosure, neither the first abutment piece 41 nor the second abutment piece 42 is electrically connected to a circuit board. In other words, the first abutment piece 41 and the second abutment piece 42 are used to abut against the two sides of the mating tongue plate 200, but they are not provided with any tail portion configured to be mounted on the circuit board.

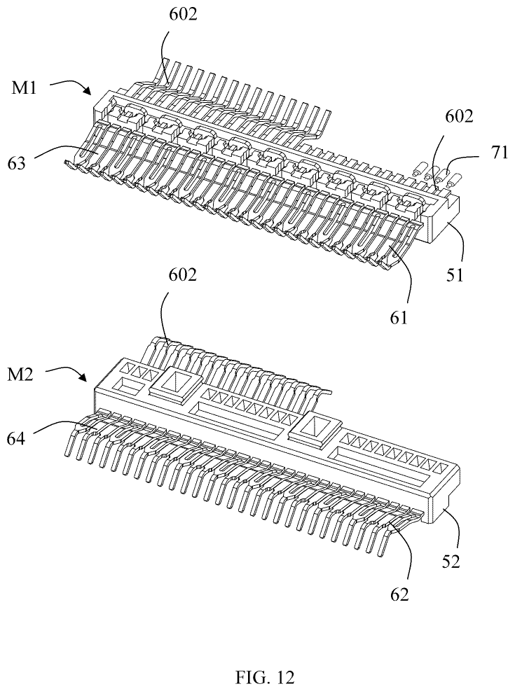

Referring to FIG. 12 to FIG. 15, in the illustrated embodiment of the present disclosure, the first terminal module M1 includes a first insulating block 51 and a plurality of first conductive terminals 61 fixed to the first insulating block 51. The first terminal module M1 is installed on the body portion 1 from the first installation opening 110. In the illustrated embodiment of the present disclosure, the plurality of first conductive terminals 61 are insert-molded with the first insulating block 51. Of course, it is understandable to those skilled in the art that in other embodiments of the present disclosure, the plurality of first conductive terminals 61 can also be fixed to the first insulating block 51 through assembly or other means.

In the illustrated embodiment of the present disclosure, the plurality of first conductive terminals 61 are arranged at intervals along a third direction A3-A3 (for example, a left-right direction). The plurality of first conductive terminals 61 include at least one pair of first differential signal terminals DP1, a first ground terminal G1 located on one side of the pair of first differential signal terminals DP1, and a second ground terminal G2 located on another side of the pair of first differential signal terminals DP1.

Similarly, in the illustrated embodiment of the present disclosure, the second terminal module M2 includes a second insulating block 52 and a plurality of second conductive terminals 62 fixed to the second insulating block 52. The second terminal module M2 is installed on the body portion 1 from the second installation opening 120. In the illustrated embodiment of the present disclosure, the plurality of second conductive terminals 62 are insert-molded with the second insulating block 52. Of course, it is understandable to those skilled in the art that in other embodiments of the present disclosure, the plurality of second conductive terminals 62 can also be fixed to the second insulating block 52 through assembly or other means.

In the illustrated embodiment of the present disclosure, the plurality of second conductive terminals 62 are arranged at intervals along the third direction A3-A3 (for example, the left-right direction). The plurality of second conductive terminals 62 include at least one pair of second differential signal terminals DP2, a third ground terminal G3 located on one side of the pair of second differential signal terminals DP2, and a fourth ground terminal G4 located on another side of the pair of second differential signal terminals DP2.

Besides, in the illustrated embodiment of the present disclosure, the first terminal module M1 further includes a plurality of third conductive terminals 63 fixed to the first insulating block 51. The plurality of third conductive terminals 63 are arranged at intervals along the third direction A3-A3. The plurality of third conductive terminals 63 include at least one pair of third differential signal terminals DP3, a fifth ground terminal G5 located on one side of the pair of third differential signal terminals DP3, and a sixth ground terminal G6 located on another side of the pair of third differential signal terminals DP3.

The second terminal module M2 further includes a plurality of fourth conductive terminals 64 fixed to the second insulating block 52. The plurality of fourth conductive terminals 64 are arranged at intervals along the third direction A3-A3. The plurality of fourth conductive terminals 64 include at least one pair of fourth differential signal terminals DP4, a seventh ground terminal G7 located on one side of the pair of fourth differential signal terminals DP4, and an eighth ground terminal G8 located on another side of the pair of fourth differential signal terminals DP4.

In the illustrated embodiment of the present disclosure, a general concept of the plurality of first conductive terminals 61, the plurality of second conductive terminals 62, the plurality of third conductive terminals 63 and the plurality of fourth conductive terminals 64 is conductive terminals 60.

In the illustrated embodiment of the present disclosure, each conductive terminal 60 includes an elastic contact arm 601 and a tail portion 602. The elastic contact arm 601 includes a contact portion 6011 protruding into the mating slot 150. The elastic contact arms 601 of the first conductive terminals 61 and the elastic contact arms 601 of the second conductive terminals 62 are arranged face to face to jointly clamp the mating tongue plate 200. The elastic contact arms 601 of the third conductive terminals 63 and the elastic contact arms 601 of the fourth conductive terminals 64 are arranged face to face to jointly clamp the mating tongue plate 200.

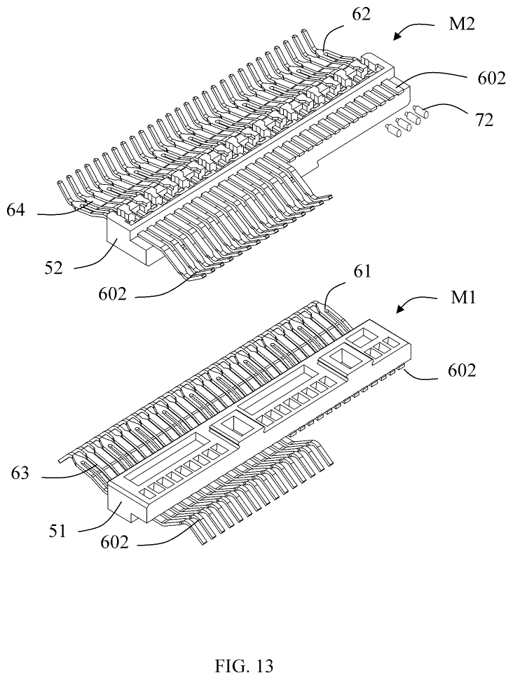

Referring to FIG. 12 and FIG. 13, in the illustrated embodiment of the present disclosure, the tail portion 602 of the first conductive terminal 61 is flat-shaped and exposed to the first insulating block 51. The tail portion 602 of the first conductive terminal 61 is configured to be electrically connected to a first cable 71. The tail portion 602 of the second conductive terminal 62 is flat-shaped and exposed to the second insulating block 52. The tail portion 602 of the second conductive terminal 62 is configured to be electrically connected to a second cable 72.

In the illustrated embodiment of the present disclosure, the tail portion 602 of the third conductive terminal 63 is cantilever-shaped and extends out of the first insulating block 51. The tail portion 602 of the fourth conductive terminal 64 is cantilever-shaped and extends out of the second insulating block 52. The tail portions 602 of the third conductive terminals 63 and the tail portions 602 of the fourth conductive terminals 64 both protrude into the mounting slot 160 and are configured to be electrically connected to an adapter circuit board 8 which is inserted into the mounting slot 160. The tail portions 602 of the third conductive terminals 63 and the tail portions 602 of the fourth conductive terminals 64 jointly clamp the adapter circuit board 8.

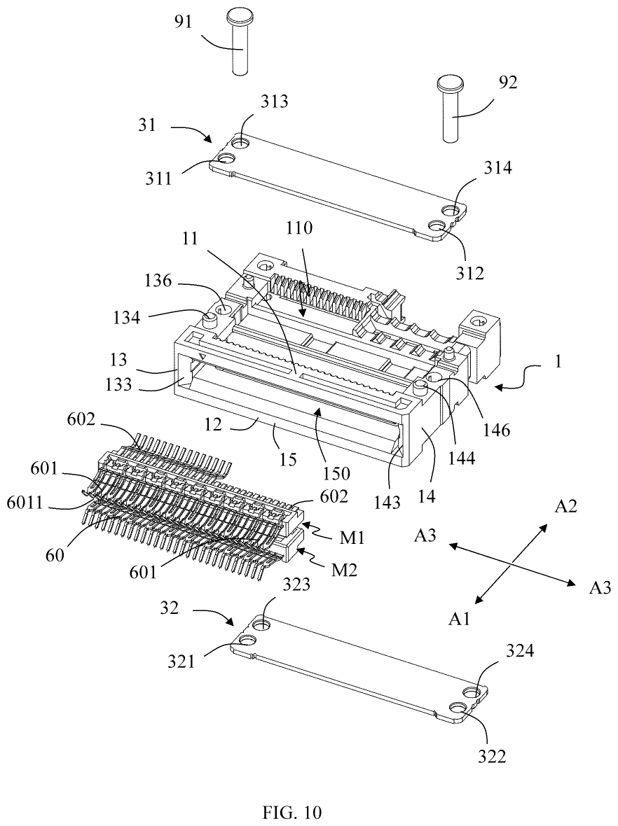

Referring to FIG. 10, the first cover plate 31 at least partially covers the first installation opening 110. In the illustrated embodiment of the disclosure, the first cover plate 31 defines a first positioning hole 311 mating with the first positioning post 134, a third positioning hole 312 mating with the third positioning post 144, a first opening 313 aligned with the first through hole 136, and a second opening 314 aligned with the second through hole 146.

The second cover plate 32 at least partially covers the second installation opening 120. In the illustrated embodiment of the present disclosure, the second cover plate 32 defines a second positioning hole 321 mating with the second positioning post 135, a fourth positioning hole 322 mating with the fourth positioning post 145, a third opening 323 aligned with the first through hole 136, and a fourth opening 324 aligned with the second through hole 146.

In the illustrated embodiment of the present disclosure, the electrical connector 100 further includes a first fastener 91 (for example, a first bolt) inserted into the first opening 313, the first through hole 136 and the third opening 323, and a second fastener 92 (for example, a second bolt) inserted into the second opening 314, the second through hole 146 and the fourth opening 324. With this arrangement, the first cover plate 31 and the second cover plate 32 are both fixed to the body portion 1, and cover the first installation opening 110 and the second installation opening 120, respectively.

Compared with the prior art, the first abutting elastic arm 413 and the second abutting elastic arm 423 are located on two sides of the mating slot 150, respectively, along the third direction A3-A3. The third direction A3-A3 is perpendicular to the first direction A1 and the second direction A2. The first abutting elastic arm 413 protrudes toward the second abutting elastic arm 423 along the third direction A3-A3. The second abutting elastic arm 423 protrudes toward the first abutting elastic arm 413 along the third direction A3-A3. The first abutting elastic arm 413 and the second abutting elastic arm 423 are configured to abut against the first side surface 203 and the second side surface 204 of the mating tongue plate 200, respectively. As a result, when the mating tongue plate 200 is inserted into the mating slot 150, the first abutting elastic arm 413 and the second abutting elastic arm 423 can automatically guide the mating tongue plate 200. That is, the mating tongue plate 200 can adjust contact positions with the contact portions 6011 of the conductive terminals 60 along the third direction A3-A3. The present disclosure improves the mating reliability and mating accuracy when the electrical connector 100 and the mating tongue plate 200 are mated, and reduces the risk of poor contact caused by the offset of the mating tongue plate 200 along the third direction A3-A3. In addition, by using the first abutting elastic arm 413 and the second abutting elastic arm 423 to guide the mating tongue plate 200, the tolerance requirements for related parts are reduced, thereby reducing the processing difficulty and improving the product yield. Since the first abutment piece 41 and the second abutment piece 42 of the present disclosure are elastic, they can be used repeatedly when inserting and removing the mating tongue plate 200 multiple times.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a body portion, the body portion comprising a mating surface and a mating slot extending through the mating surface along a first direction; the mating slot being configured to at least partially receive a mating tongue plate along a second direction opposite to the first direction; the mating tongue plate comprising a first side surface and a second side surface opposite to the first side surface;
a plurality of conductive terminals, the plurality of conductive terminals being provided on the body portion; each conductive terminal comprising an elastic contact arm which comprises a contact portion protruding into the mating slot;
a first abutment piece, the first abutment piece being provided on the body portion, the first abutment piece comprising a first abutting elastic arm protruding into the mating slot; and
a second abutment piece, the second abutment piece being provided on the body portion, the second abutment piece comprising a second abutting elastic arm protruding into the mating slot;
wherein the first abutting elastic arm and the second abutting elastic arm are disposed on two sides of the mating slot, respectively, along a third direction; the third direction is perpendicular to the first direction and the second direction; the first abutting elastic arm protrudes toward the second abutting elastic arm along the third direction; the second abutting elastic arm protrudes toward the first abutting elastic arm along the third direction; the first abutting elastic arm and the second abutting elastic arm are configured to abut against the first side surface and the second side surface of the mating tongue plate, respectively, so that the mating tongue plate is caused to adjust contact positions with the contact portions of the conductive terminals along the third direction during a process of inserting the mating tongue plate into the mating slot.

2. The electrical connector according to claim 1, wherein the mating tongue plate is made of a printed circuit board; the mating tongue plate comprises a plurality of conductive pads which are configured to be in contact with the contact portions of the conductive terminals.

3. The electrical connector according to claim 1, wherein the body portion comprises a first side wall and a second side wall opposite to the first side wall; the mating slot is located between the first side wall and the second side wall;
the first side wall defines a first fixing groove; the first abutment piece comprises a first main body portion fixed in the first fixing groove; the first abutting elastic arm is integrally stamped from the first main body portion;
the second side wall defines a second fixing groove; the second abutment piece comprises a second main body portion fixed in the second fixing groove; the second abutting elastic arm is integrally stamped from the second main body portion.

4. The electrical connector according to claim 3, wherein the first side wall comprises a first inclined surface disposed adjacent to the mating surface; the second side wall comprises a second inclined surface disposed adjacent to the mating surface; the first inclined surface and the second inclined surface form a bell mouth configuration.

5. The electrical connector according to claim 4, wherein the first abutment piece comprises a first deflection portion extending from the first main body portion, and the first deflection portion is in contact with the first inclined surface;
the second abutment piece comprises a second deflection portion extending from the second main body portion, and the second deflection portion is in contact with the second inclined surface;
the first deflection portion and the second deflection portion are configured to guide the mating tongue plate to be inserted into the mating slot along the second direction.

6. The electrical connector according to claim 3, wherein the first fixing groove extends along the first direction, and the first main body portion is inserted into and fixed in the first fixing groove along the second direction;
the second fixing groove extends along the first direction, and the second main body portion is inserted into and fixed in the second fixing groove along the second direction.

7. The electrical connector according to claim 3, wherein the first main body portion comprises a first frame portion arranged around the first abutting elastic arm; and the second main body portion comprises a second frame portion arranged around the second abutting elastic arm.

8. The electrical connector according to claim 1, wherein the first abutting elastic arm and the second abutting elastic arm both extend along the first direction; the first abutting elastic arm is provided with an arc-shaped first abutting surface; the second abutting elastic arm is provided with an arc-shaped second abutting surface; the first abutting surface and the second abutting surface are configured to abut against the first side surface and the second side surface of the mating tongue plate, respectively.

9. The electrical connector according to claim 1, wherein the first abutment piece and the second abutment piece are both metal pieces; the body portion is an insulating body portion.

10. The electrical connector according to claim 1, wherein neither the first abutment piece nor the second abutment piece is electrically connected to a circuit board.

11. The electrical connector according to claim 1, wherein the body portion further comprises a top wall and a bottom wall; the mating slot is jointly enclosed by the top wall, the bottom wall, the first side wall and the second side wall; the top wall defines a first installation opening; the bottom wall defines a second installation opening;
the electrical connector comprises a first terminal module and a second terminal module;
the first terminal module comprises a first insulating block and a plurality of first conductive terminals fixed to the first insulating block; the first terminal module is installed on the body portion from the first installation opening;
the second terminal module comprises a second insulating block and a plurality of second conductive terminals fixed to the second insulating block; the second terminal module is installed on the body portion from the second installation opening;
the plurality of conductive terminals comprise the plurality of first conductive terminals and the plurality of second conductive terminals;
the elastic contact arms of the first conductive terminals and the elastic contact arms of the second conductive terminals are disposed face to face to jointly clamp the mating tongue plate.

12. The electrical connector according to claim 11, wherein the plurality of first conductive terminals are arranged at intervals along the third direction; the plurality of first conductive terminals comprise at least one pair of first differential signal terminals, a first ground terminal located on one side of the at least one pair of first differential signal terminals, and a second ground terminal located on another side of the at least one pair of first differential signal terminals;
the plurality of second conductive terminals are arranged at intervals along the third direction; the plurality of second conductive terminals comprise at least one pair of second differential signal terminals, a third ground terminal located on one side of the at least one pair of second differential signal terminals, and a fourth ground terminal located on another side of the at least one pair of second differential signal terminals.

13. The electrical connector according to claim 12, wherein each conductive terminal comprises a tail portion;
the tail portion of the first conductive terminal is flat-shaped and exposed to the first insulating block to be electrically connected to a first cable;
the tail portion of the second conductive terminal is flat-shaped and exposed to the second insulating block to be electrically connected to a second cable.

14. The electrical connector according to claim 12, wherein the first terminal module further comprises a plurality of third conductive terminals fixed to the first insulating block; the plurality of third conductive terminals are arranged at intervals along the third direction; the plurality of third conductive terminals comprise at least one pair of third differential signal terminals, a fifth ground terminal located on one side of the at least one pair of third differential signal terminals, and a sixth ground terminal located on another side of the at least one pair of third differential signal terminals;
the second terminal module further comprises a plurality of fourth conductive terminals fixed to the second insulating block; the plurality of fourth conductive terminals are arranged at intervals along the third direction; the plurality of fourth conductive terminals comprise at least one pair of fourth differential signal terminals, a seventh ground terminal located on one side of the at least one pair of fourth differential signal terminals, and an eighth ground terminal located on another side of the at least one pair of fourth differential signal terminals.

15. The electrical connector according to claim 14, wherein each conductive terminal comprises a tail portion;
the tail portion of the third conductive terminal is cantilever-shaped and extends out of the first insulating block;
the tail portion of the fourth conductive terminal is cantilever-shaped and extends out of the second insulating block;
the body portion comprises a rear end surface opposite to the mating surface and a mounting slot extending through the rear end surface; the tail portion of the third conductive terminal and the tail portion of the fourth conductive terminal both protrude into the mounting slot, and are configured to be electrically connected to an adapter circuit board which is inserted into the mounting slot.

16. The electrical connector according to claim 11, further comprising a first cover plate at least partially covering the first installation opening and a second cover plate at least partially covering the second installation opening; wherein the first cover plate and the second cover plate are both fixed to the body portion.

17. An electrical connector, comprising:
a body portion, the body portion comprising a mating surface and a mating slot extending through the mating surface along a first direction; the mating slot being configured to at least partially receive a mating tongue plate along a second direction opposite to the first direction; the mating tongue plate comprising a first side surface, a second side surface opposite to the first side surface and a plurality of conductive pads;
a plurality of conductive terminals, the plurality of conductive terminals being fixed to the body portion; each conductive terminal comprising an elastic contact arm which comprises a contact portion protruding into the mating slot;
a first abutment piece, the first abutment piece being fixed to the body portion, the first abutment piece comprising a first abutting elastic arm protruding into the mating slot; and
a second abutment piece, the second abutment piece being fixed to the body portion, the second abutment piece comprising a second abutting elastic arm protruding into the mating slot;
wherein the first abutting elastic arm and the second abutting elastic arm are disposed on two sides of the mating slot, respectively, along a third direction which is perpendicular to the first direction and the second direction; the first abutting elastic arm and the second abutting elastic arm are configured to abut against the first side surface and the second side surface of the mating tongue plate, respectively, to adjust a position of the mating tongue plate along the third direction when the mating tongue plate is inserted into the mating slot, ensuring that the contact portions of the conductive terminals are accurately in contact with corresponding conductive pads of the mating tongue plate.

18. The electrical connector according to claim 17, wherein neither the first abutment piece nor the second abutment piece is mounted to a circuit board.

19. An electrical connector, comprising:
a body portion comprising a mating surface, a mating slot extending through the mating surface along a first direction, a first side wall located on one side of the mating slot, and a second side wall located on another side of the mating slot; the first side wall defining a first fixing groove; the second side wall defines a second fixing groove; the mating slot being configured to at least partially receive a mating tongue plate along a second direction opposite to the first direction; the mating tongue plate comprising a first side surface, a second side surface opposite to the first side surface and a plurality of conductive pads;
a first terminal module comprising a first insulating block and a plurality of first conductive terminals fixed to the first insulating block; the first terminal module being assembled to the body portion; the plurality of first conductive terminals extending into the mating slot;
a second terminal module comprising a second insulating block and a plurality of second conductive terminals fixed to the second insulating block; the second terminal module being assembled to the body portion; the plurality of second conductive terminals extending into the mating slot;
a first abutment piece comprising a first main body portion fixed in the first fixing groove and a first abutting elastic arm integrally stamped from the first main body portion; and
a second abutment piece comprising a second main body portion fixed in the second fixing groove and second abutting elastic arm integrally stamped from the second main body portion;
wherein the first abutting elastic arm and the second abutting elastic arm are disposed on two sides of the mating slot, respectively, along a third direction which is perpendicular to the first direction and the second direction;
wherein a width of the mating slot along the third direction is larger than a width of the mating tongue plate between the first side surface and the second side surface, so that the mating tongue plate can be easily inserted into the mating slot; and
wherein the first abutting elastic arm and the second abutting elastic arm are configured to abut against the first side surface and the second side surface of the mating tongue plate, respectively, to adjust a position of the mating tongue plate along the third direction when the mating tongue plate is inserted into the mating slot, ensuring that the plurality of first conductive terminals and the plurality of second conductive terminals are accurately in contact with corresponding conductive pads of the mating tongue plate.

20. The electrical connector according to claim 19, wherein neither the first abutment piece nor the second abutment piece is mounted to a circuit board.
